(19) United States
(12) Patent Application Publication
(10) Pub. No.: US 2019/0247752 A1
(43) Pub. Date: Aug. 15, 2019

(54) Interactive Golfing System and Method

(71) Applicants: SOGO Sports Pty Ltd, Gosford (AU); Alive Mobile, Mosman (AU)

(72) Inventors: Daniel Walter Seymour, Kirribilli (AU); Daniel Bruce Newton, Forbes (AU); David Stafford Elliott, Terrigal (AU); Casey Hendrick van Loo, Kirribilli (AU); Leandro Gama, Mosman (AU); Rachel Williams, Mosman (AU); Kristin De La Fuente, Mosman (AU); Marc Decerle, Mosman (AU)

(21) Appl. No.: 15/777,186

(22) PCT Filed: Nov. 18, 2016
(86) PCT No.: PCT/AU2016/000382

§ 371 Date: May 17, 2018

Related U.S. Application Data
(60) Provisional application No. 62/257,541, filed on Nov. 19, 2015.

(51) Int. Cl. A63F 13/573; A63F 13/48; A63F 13/327; A63F 13/332; A63F 13/46; A63F 13/355

(52) U.S. Cl. CPC A63F 13/573; A63F 13/48; A63F 13/355; A63F 13/332; A63F 13/46; A63F 13/327

(57) ABSTRACT

A system and a computer-implemented method are disclosed. The method comprises the steps of: receiving, from a golfer mobile device, a request to conduct a round of golf, the request comprising round information and identification of a validator mobile device, receiving, from the validator mobile device, confirmation of validator status, receiving, from the golfer mobile device, score data and location data of the golfer mobile device. The method further comprises receiving, from the validator mobile device, location data of the validator mobile device, determining whether the received score data is valid by comparing the location data of the golfer mobile device to the location data of the validator mobile device, and determining and recording a score based on the score data for the golfer if the received score data is determined to be valid.

### RELATED APPLICATIONS

This application claims the benefit of priority from U.S. Provisional Patent Application No. 62/257541, filed on 19 Nov. 2015, hereby incorporated by reference in its entirety as if fully set forth herein.

### TECHNICAL FIELD

The present invention relates generally to systems and methods for conducting a game of golf and, in particular, for conducting an interactive game of golf. The present invention also relates to a computer program product including a computer readable medium having recorded thereon a computer program for conducting an interactive game of golf.

### BACKGROUND

Many golfers, including amateur golfers, enjoy entering golfing competitions. In order to compete in a golfing competition, a golfer is generally required to play on a given course, often on a given day and, in some cases, at a given time.

However, many golfers, particularly amateur golfers, are limited in what times they can visit a golf course, and accordingly find such competition arrangements inconvenient. As a result, some golfers do not enter as many competitions as they desire. Requiring a competition to be played at a particular time on a particular golf course can limit the number of players in a golfing competition. Further, golfers who want to play golf without entering a competition may be inconvenienced if a golf course is only available to competitors on a competition day. Operating golfing competitions in such a manner may accordingly be inconvenient to many golfers.

Operating golfing competitions in such a manner may also be unsatisfactory to operators of golf courses and golf clubs, as membership and use of the clubs and courses can be affected. Further, present competition arrangements often do not provide insight to operators of golf courses and golf clubs regarding golfer participation rates and popular golfing times.

### SUMMARY

It is an object of the present disclosure to substantially overcome, or at least ameliorate, one or more disadvantages of existing arrangements.

According to a first aspect of the present disclosure there is provided a computer-implemented method, comprising the steps of: receiving, from a golfer mobile device, a request to conduct a round of golf, the request comprising round information and identification of a validator mobile device, receiving, from the validator mobile device, confirmation of validator status, receiving, from the golfer mobile device, score data and location data of the golfer mobile device, receiving, from the validator mobile device, location data of the validator mobile device, determining whether the received score data is valid by comparing the location data of the golfer mobile device to the location data of the validator mobile device, and determining and recording a score based on the score data for the golfer if the received score data is determined to be valid.

In a further aspect, determining if the received score data is valid comprises receiving a score validation confirmation from the validator mobile device with the location data of the validator mobile device.

In a further aspect, determining if the received score data is valid comprises determining if the location data of the validator mobile device and the location data of the golfer mobile device are the same.

In a further aspect, determining if the received score data is valid comprises determining if the location of the golfer mobile device and the location of the validator mobile device lie within a predetermined radius of one another.

In a further aspect, determining if the received score data is valid comprises determining if the location of the golfer mobile device and the location of the validator mobile device correspond to a location of a golf course included in the round information.

In a further aspect, determining if the received score data is valid comprises determining if the location of the golfer mobile device and the location of the validator mobile device lie within a given radius of the location of the golf course.

In a further aspect, determining if the received score data is valid comprises determining if the location of the golfer mobile device and the location of the validator mobile device lie within a geo-fence associated with the golf course.

A further aspect of the method further comprises comparing the determined score to a performance history of the golfer, determining if the determined score relates to an achievement relative to the performance history, transmitting a notification message if the determined score relates to an achievement relative to the performance history and updating the performance history of the golfer.

A further aspect of the method further comprises comparing the determined score to performance history of a number of golfers, determining if the determined score relates to an achievement relative to the performance history of the number of golfers and transmitting a notification message if the determined score relates to an achievement relative to the performance history of the number of golfers.

In a further aspect, the round information includes location data of the golfer device at a time the request is made; the confirmation of validator status includes location data of the validator mobile device at a time the validator status is confirmed; and comparing the location data of the golfer device at a time the request is made and location data of the validator mobile device at a time the validator status is confirmed to determine if the confirmation of validator status is valid.

In a further aspect, the round information includes information regarding an updated format of a golf course; and the updated format of the golf course is determined to be valid if received from a predetermined number of other mobile devices on a given day.

A further aspect of the method further comprises updating a leader board based upon the score data for the hole in the round of golf.

A further aspect of the method further comprises normalising the determined score based upon one or more conditions recorded for a number of players on a golf course associated with the round of golf on a given day.

In a further aspect, receiving the confirmation of validator status comprises transmitting a notification to the validator mobile device; and receiving the confirmation in response to the notification from the validator mobile device.

In a further aspect, the notification comprises a text message containing a uniform resource locator for a website by which the confirmation can be received.

In a further aspect, an identity of a validator associated with the validator mobile device is validated using a registration of a handicap database.

A further aspect of the method further comprises transmitting a request for a daily handicap for the golfer to a handicap database upon receiving the request to play a round of golf; receiving the daily handicap from the handicap database; and determining the score based upon the daily handicap.

Another aspect of the present disclosure provides a system comprising: a golfer mobile device; a validator mobile device, a server computer; and a communications network, the server computer being in communication with the golfer mobile device, the server computer configured to: receive, from the golfer mobile device, a request to conduct a round of golf, the request comprising round information, identification of the validator mobile device, receive, from the validator mobile device, confirmation of validator status, receive, from the golfer mobile device, score data and location data of the golfer mobile device, receive, from the validator mobile device, location data of the validator mobile device, determine whether the received score data is valid by comparing the location data of the golfer mobile device to the location data of the validator mobile device, and determine and record a score based on the score data for the golfer if the received score data is determined to be valid.

Another aspect of the present disclosure provides a non-transitory computer readable storage medium having a computer program stored thereon comprising code for: receiving, from a golfer mobile device, a request to conduct a round of golf, the request comprising round information, identification of a validator mobile device, receiving, from the validator mobile device, confirmation of validator status, receiving, from the golfer mobile device, score data and location data of the golfer mobile device, receiving, from the validator mobile device, location data of the validator mobile device, determining whether the received score data is valid by comparing the location data of the golfer mobile device to the location data of the validator mobile device, and determining and recording a score based on the score data for the golfer if the received score data is determined to be valid.

Other aspects are also disclosed.

### BRIEF DESCRIPTION OF THE DRAWINGS

At least one embodiment of the present invention will now be described with reference to the drawings, in which:

FIG. 1A shows a system for conducting an interactive golfing system.

FIGS. 1B and 1C form a schematic block diagram of a general purpose computer system upon which arrangements described can be practiced;

FIG. 2 shows a schematic flow diagram of an interactive golfing method;

FIG. 3 shows a data flow between a golfer mobile device and a validator mobile device for the interactive golfing method of FIG. 2;

FIGS. 4A and 4B each show a schematic flow diagram of a method of providing data feedback to a golfer mobile device;

FIGS. 5A to 5F show example feedback presented on a display of a golfer mobile device;

FIG. 6 shows a schematic flow diagram of a method of obtaining a daily handicap;

FIGS. 7A and 7B illustrate update of a live leader board; and

FIG. 8 shows a relationship between updating a live leader board and updating competition results.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

Use of mobile communications devices has become increasingly popular with the development of smartphones and tablet computers. The arrangements described herein relate generally to a method and system for playing golf by interaction with a mobile communications device. The arrangements described relate to a golfer nominating a validator to validate the golfer's play or score data for a round of golf. Both the golfer and the validator each have, and interact with, a mobile communications device. The mobile devices are used to record and validate the golfer's score for the round of golf.

The arrangements described allow a competition to be held for a number of golfers even if the golfers play on different golf courses at different times. Additionally, the arrangements described allow the validated data to be used to provide meaningful feedback to the golfer and data which may be of value to a golf course operator.

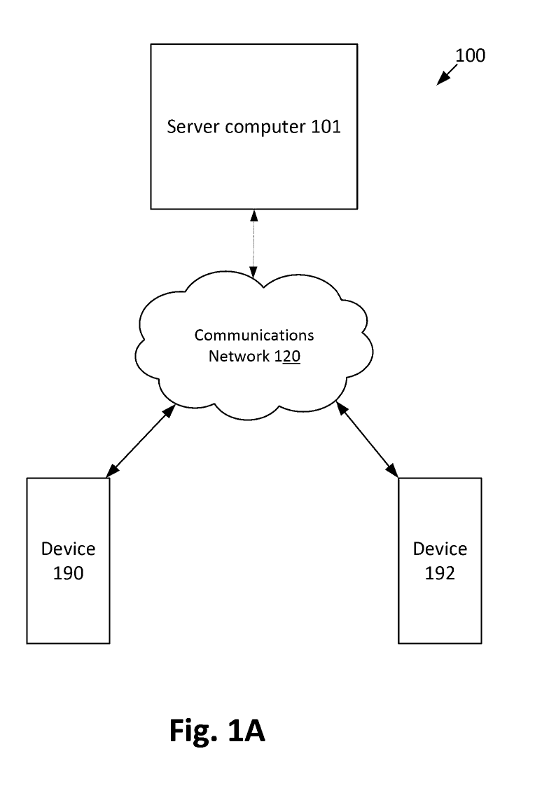

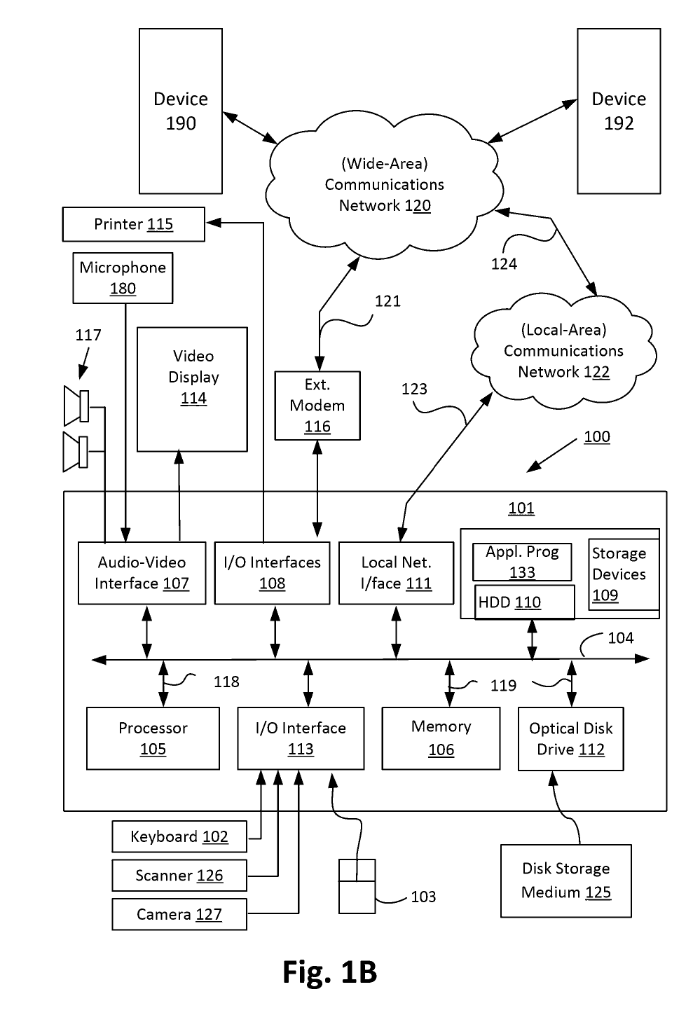

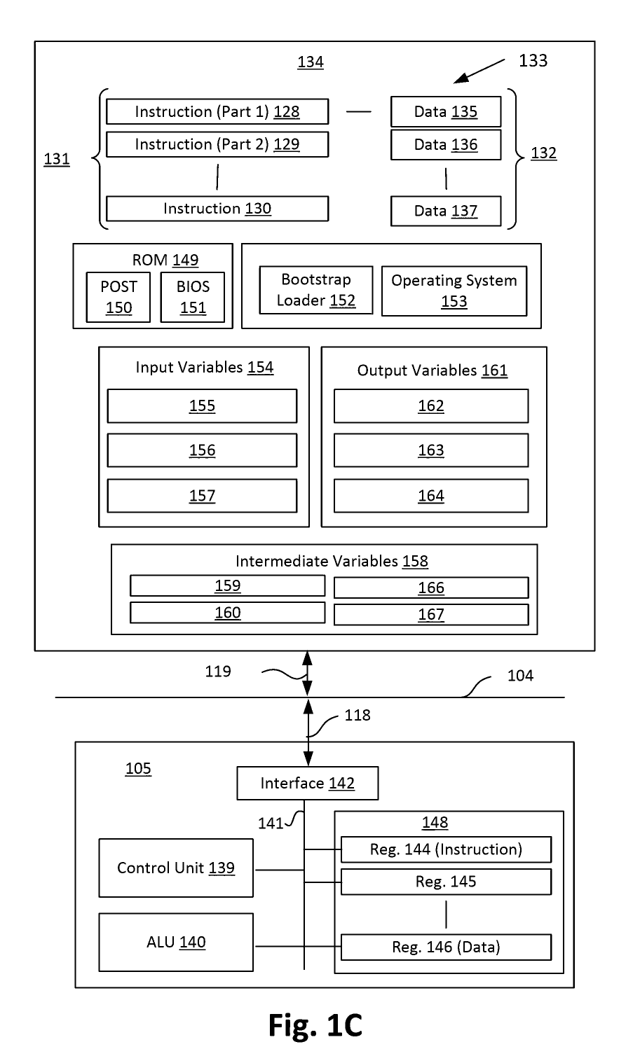

FIG. 1A shows a system 100 for interactive golf. The system 100 includes a server computer module 101, a mobile device 190 used by the golfer (also referred to as the golfer device or golfer mobile device), a mobile device 192 operated by the validator (also referred to as the validator device or validator mobile device) and a communications network 120.

The server computer 101 is operated and maintained by a service provider of the interactive golf system and method. While shown as a single computing device in the arrangements described, the server computer 101 may comprise a number of computer devices, for example a number of cloud computing servers.

The server computer 101 can communicate with each of the mobile devices 190 and 192 via the network 120. The network 120 is may comprise one or more wireless telecommunications networks, such as GSM networks, CDMA networks, 3GPP networks, and the like. Alternatively, or additionally, the network may be a wireless network using standards such as Wi-Fi (including protocols based on the standards of the IEEE 802.11 family), Infrared Data Association (IrDa) and the like. The network 120 may also comprise a combination of wired and wireless networks. An example of a wired connection includes Ethernet.

The golfer mobile device 190 is used by a golfer who wants to play a round of golf using the interactive method. The validator mobile device 192 is used by a validator who validates the golfer's round of golf. The golfer and the validator interact with the devices 190 and 192 respectively in conducting the game of golf.

FIGS. 1B and 1C depict the system 100 showing the server computer 101, upon which the various arrangements described can be practiced, in greater detail.

As seen in FIG. 1B, the computer system 100 includes: a computer module (server computer) 101; input devices such as a keyboard 102, a mouse pointer device 103, a scanner 126, a camera 127, and a microphone 180; and output devices including a printer 115, a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module (server computer) 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1B, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

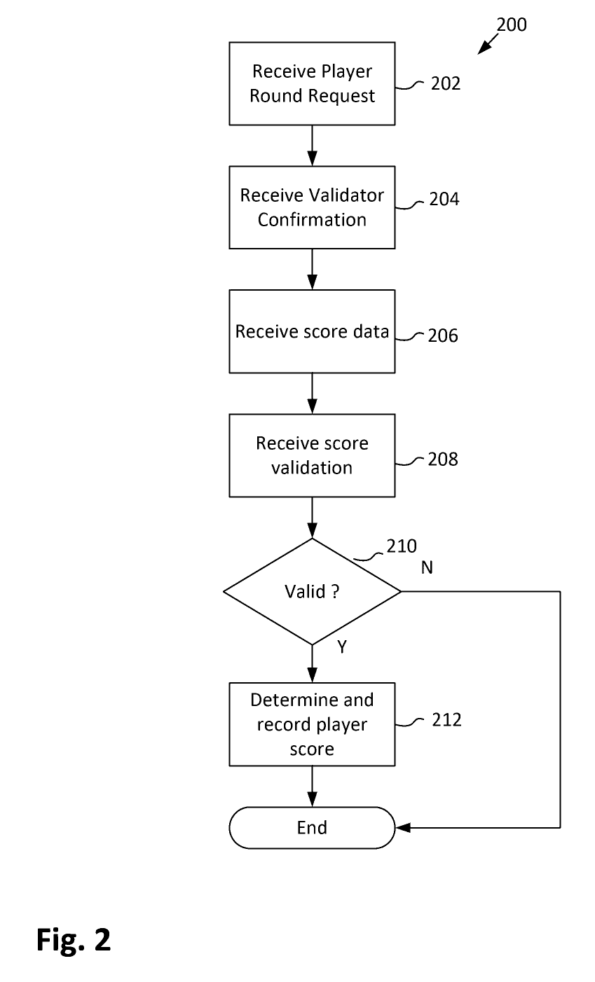

The methods of FIGS. 2, 4A, 4B and 6 may be implemented using the computer system 100 as one or more software application programs 133 executable within the computer system 100. In particular, the steps of the method of FIG. 2 are effected by instructions 131 (see FIG. 1C) in the software 133 that are carried out within the computer system 100. The software instructions 131 may be formed as one or more code modules, each for performing one or more particular tasks. The software may also be divided into two separate parts, in which a first part and the corresponding code modules performs the described methods and a second part and the corresponding code modules manage a user interface between the first part and the user. The software application 133 may be an enterprise application such that simultaneous services may be provided to a plurality of mobile devices over the network 120.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for the interactive golfing method and system.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for the interactive golfing method and system.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1C is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1B.

When the computer module 101 is initially powered up, a power-on self-test (POST) program 150 executes. The POST program 150 is typically stored in a ROM 149 of the semiconductor memory 106 of FIG. 1B. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1B. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1B must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1C, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1B. The execution of a set of the instructions may in some cases result in output of data. Execution may also involve storing data or variables to the memory 134.

The disclosed arrangements use input variables 154, which are stored in the memory 134 in corresponding memory locations 155, 156, 157. The disclosed arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 10, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2, 4A, 4B and 6 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The golfer mobile device 190 and the validator mobile device 192 may each be any type of mobile device such as a smartphone, tablet, and the like. The golfer device 190 and the validator device 192 each typically comprise a memory, a processor and inputs/outputs by which a user can interact with said device, and operate in a similar manner to the computer module 101 as described above. However, the golfer device 190 and the validator device 195 each have relatively limited processing resources compared to a computing device such as a desktop computer or server computer.

Examples of inputs and outputs by which the golfer and validator users can interact with the devices 190 and 192 include a keyboard, a touch sensitive screen, and the like. Each of the devices 190 and 192 are configured for displaying graphical images on a video display (not illustrated). The devices 190 and 192 may include a touch sensitive panel physically associated with the video display to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands.

The devices 190 and 192 are capable of communication with one another and other devices across one or more telecommunications networks, such as a GSM network, a 3GPP network, a CDMA network and the like. The devices 190 and 192 are capable of executing applications by which the user can interact with remote servers such as cloud computing servers, such as unction-specific applications and browser applications such as Microsoft Internet Explorer™, Google Chrome™, Apple Safari™ and the like.

The devices 190 and 192 are capable of determining and providing location data describing the respective device's location in geographic coordinates. The location data for the respective device may be derived in a number of ways, dependent upon the model, operating system and applications installed on the devices 190 and 192. For example, each device 190 and 192 may comprise GPS circuitry from which a location may be determined via satellite communications. In other arrangements, location services in the devices 190 and 192 may be determined in relation to signal strengths provided between that device and a base station of a cellular communications network.

Score Validation

FIG. 2 shows a method 200 for conducting an interactive game of golf. The method 200 is implemented by the application 133 stored in the memory 106 and controlled by execution of the processor 105 of the server computer 101.

The method 200 starts at step 202 when the golfer interacts with inputs of the golfer device 190 to transmit a request to play a round of golf to the server computer 101. The request is normally transmitted in a predetermined format, such as a pull notification, and typically comprises round information identifying the golfer, a nominated golf course and tee box, and a validator of the round. The round request may also include location data describing a location of the golfer device 190. Location data normally describes a geographic location of the golfer device 190 in terms of GPS coordinates. However, in some arrangements, the location data may not be included in the request.

The request is prepared by the golfer manipulating inputs of the golfer device 190 to interact with a specific golfing graphical user interface application installed on the device 190, hereafter referred to as the “golf GUI”. The golf GUI is normally a function-specific application provided by the service provider. The golf GUI is typically installed on the golfer device 190 via communication with the server computer 101 when the user first registers as a user of the service provided via the server computer 101. The details included in the request may be selected using standard GUI selection techniques such as a drop-down box, entering text, and the like. If location data is required, the golf GUI queries the operating system of the golfer device 190 and receives location data in reply.

The golfer normally has an associated account registered with the service provider for recording associated scores. The account may be stored on a memory of the server computer 101, such as the memory 106. The golfer account may be associated with one or more databases stored on the server computer 101. Alternatively, the database may be stored external to the server computer 101. The golfer account may be associated with an identifier of the golfer device 190 for conducting communications, such as a telephone number. The golfer may pay a subscription for use of the service provided via the server computer 101. The golfer account may in some instances be accessed by entering of a username and password to the golf GUI in the traditional manner.

Returning to FIG. 2, the validator must play the round of golf with the golfer, as one of the golfer's playing partners. The validator is responsible for monitoring the golfer's recorded score for accuracy, as well as ensuring that the golfer is adhering to the rules of golf. The validator does not necessarily have a registered account with the service provider, or have an application for the golf GUI installed on the validator device 192. However, the validator must have a handicap registration with a handicap registration service with which the service provider of the server computer 101 has an arrangement, and to which the service provider has access. For example, in Australia the service provider may have access to a GolfLink handicap database. Such provides confidence in the validator's identity and knowledge of the rules of golf, effectively providing a means of validating the identity of the nominated validator.

If the validator has the golf GUI installed on the validator device 192, the golfer has to search for the validator by name, and then select the user as their validator using the golf application. If the validator is not a registered user of the service provider, at step 202, the golfer enters details identifying the validator and by which a notification may be sent to the validator device 192, such as a mobile telephone number for the validator device 192.

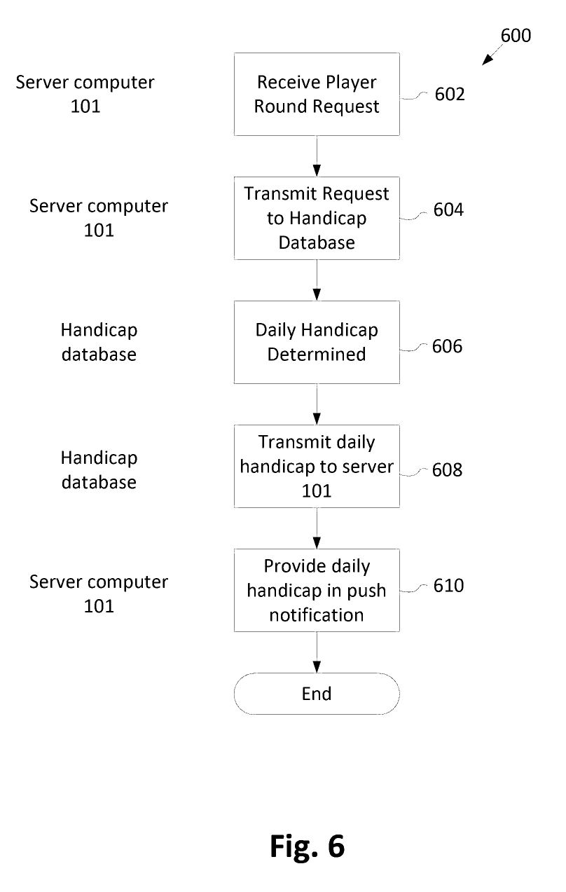

The server computer 101 receives the request to play a round of golf via the network 120 at step 202. Upon receiving the round request at step 202, the application 133 typically executes to request a daily handicap associated with the golfer from the handicap database. A method 600 of obtaining a daily handicap is described hereafter in relation to FIG. 6. The daily handicap may be transmitted to the golfer device 190 via a push notification for the golfer's reference.

The method 200 progresses from step 202 to step 204. At step 204, the validator accepts, by interaction with the device 192, the request to validate the golfer's round.

Upon the server computer receiving the request at step 202, the server computer 101 subsequently executes at step 204 to transmit a notification to the validator device 192. If the validator is a registered user of the golf GUI, the notification is a push notification transmitted to the validator device 192 for display via the golf GUI. The notification prompts the validator them to confirm their status as validator for the golfer's round. The validator interacts with a session of the golf GUI executing on the validator device 192 to accept the request and confirm status as a validator. The server computer receives the confirmation in response to the notification from the validator

If the validator is not a registered user of the golf GUI, the server computer executes to send the notification in form of an SMS message to the validator device 192 containing a unique Uniform Resource Locator (URL). The URL included in the SMS message directs the validator to open a website via a browser application executable on the validator device 192. The validator is prompted to confirm their status as validator for the golfer's round on the website. The website provides a means by which the status confirmation can be received by the server computer.

The website may also provide a means by which the identity of the validator may be validated using a registration of the handicap database. For example, the validator may be prompted to enter identification details including a name, telephone number and a handicap registration number. The server computer executes to receive the identification details via the website and transmit the identification details to the handicap database via an application program interface (API) for validation of the identity of the validator. If the server computer does not receive confirmation of the validator identity from the handicap server, the application 133 will not consider the validation confirmation to be valid.

In some implementations, the validator may be required to provide a further proof of identification, such as by transmitting a photograph of a handicap registration card. The photograph may for example be captured using a camera installed on the validator device and transmitted to the server computer via upload to the website using the validator device. The photograph may be analysed automatically using optical recognition techniques on the server computer or manually inspected by a user of the server computer.

The server computer 101 receives the confirmation of validator status at step 204 from the validator device 192 either by a transmission initiated by the golf GUI or user interaction with the website.

Some arrangements of the method 200 use location validation. In such arrangements, the application 133 executes to receive location data for the golfer device 190 at step 202 and the validator device 192 at step 204. The application 133 may execute to compare the received location data to a location of the nominated golf course stored on the computer module 101, such as in the memory 106, to verify that the validator device 192 and the golfer device 190 are in the correct location, effectively determining if the confirmation of validator status is valid. Methods of verifying or validating the location data of the golfer device 190 and the validator device 192 are described in relation to step 210. Verifying the location of the golfer mobile device 190 and the validator mobile device 192 prior to the round starting may be useful as the golfer can be confident that the validator can validate the round once completed. However, methods of conducting an interactive round of golf using location validation may not verify the location data of the golfer device 190 and the validator device 192 prior to the round of golf commencing in some implementations.

Once the validator has confirmed or accepted their role, play of the round can begin.

The method 200 executes to progress from step 204 to step 206 upon the golfer entering score data for the golfer's play of the nominated round of golf to the golf GUI. The score may be provided at the end of the round of golf or at intermediate stages of the round of golf—for example after a certain number of holes have been completed. If location validation is being used, location data of the golfer device 190 at a time of score data entry is included with the score data. The server computer 101 executes to receive the score data.

The server computer 101 transmits at least a portion of the score data to the validator device using methods similar to transmission of the validation request described above with a notification requesting the validator to approve the golfer's score. The notification may include the score data provided by the golfer. Alternatively, the notification may simply require validation of the score data, for example the validation including a declaration that the validator is aware of the score data (e.g., by playing the round with the golfer or by viewing the score data on the golfer mobile device 190).

The validator confirms, by interaction with the device 192 in the manner described above, that the score is accurate and has been attained within the rules of golf.

The method 200 progresses from step 206 to step 208. At step 208 the application 133 executes to receive a score validation from the validator device 192. The score validation is received from the validator device 192 in a similar manner to that described in relation to step 204. The score validation includes location data for the validator device 192 at the time of score validation entry if location validation is in operation.

The method 200 progresses from step 208 to step 210. At step 210, the server computer compares the location data of the validator device 1920 and the golfer device 190 to determine if the score data is valid. In other arrangements, step 210 may also compare the score validation confirmation and the received score data to determine if the score data is valid.

In arrangements using location validation, step 210 comprises comparing the location data received for the golfer device 190 and the validator device 192. The comparison may determine if the location data for each of the devices 190 and 192 is the same or within a given range. Alternatively, the comparison may comprise determining if the location data for each device corresponds to the stored location of the nominated golf course. In order to avoid errors caused by slight inaccuracies in the location services data, or by inconsistencies in the accuracy of golf course GPS coordinate data, a predetermined radius (for example, 3 kilometres) may be set around the stored golf course coordinate for the comparison of location data. If the golfer's location, as captured through location services, is within the radius, then the golfer is determined to be at the nominated golf course and the score data is determined to be valid. In other arrangements, step 210 may involve determining if the location data for the golfer device 190 and the validator device 192 are the same or with a predetermined radius of one another.

Alternatively, geo-fencing techniques may be used to determine if the score data is valid. In such arrangements, the location data of the golfer device 190 and the validator device 192 are compared to a geographic boundary of geo-fence associated with the golf course stored on the memory 106. If the location data for each of the devices 190 and 192 is within the geographic boundary, the score data is determined to be valid.

In some arrangements, the golf GUI may execute to periodically provide location data to the server computer 101, for example at 1-minute intervals. In such arrangements, the application 133 may execute to determine a trajectory of the golfer and the validator upon completion of the round, and verify that the determined trajectories correspond to the location of the golf course at step 210. In some arrangements (not shown), the location information may be transmitted to the server computer at each interval. The application 133 may execute to determine information of use to the golfer, such as distance to a green of a current hole. The determined information may be transmitted to the golfer device 190 and displayed by the golf GUI for the golfer's reference.

In arrangements which do not use location validation, step 210 may be excluded—receiving the validation confirmation at the server computer 101 may determine that the received score data is valid.

If the received score data is determined to be valid (“Y” at step 210), the method 200 proceeds to step 212. At step 212, the application 133 executes to determine a score for the golfer based on the received score data. The determined score is stored on a database of the server computer 101 and associated with the golfer account, for example in the memory 106. The method 200 then ends.

The application 133 may in some implementations transmit the determined score to the associated handicap database. In some instances, for example for a golf club competition for which the relevant golf club normally uploads competition data, the application 133 will not transmit the determined score to the handicap database. Such prevents the duplication of the determined score being received by the handicap database.

If the received score data is not determined to be valid (“N” at step 210), the method 200 ends. In alternative arrangements, the method 200 may transmit a message to each of the devices 190 and 192 comprising a notification that the score is invalid (not shown). The golfer may be prompted to enter another score, and the method 200 return to step 208 (not shown).

The method 200 is described with reference to the server computer 101. In other arrangements, some of the operations described in relation to the method 200 may be implemented by an appropriate one of the devices 190 and 192. For example, the devices 190 and 192 may be directly communication across the network 120 rather than via the server computer 101.

Further, score and/or location data may be provided to the server computer 101 at different stages of the round of golf. The validator may be prompted for validation at each stage, or only after the final score data for the round of golf has been received.

The arrangements described also provide a method for validating a change in format of a golf course. A groundskeeper of a golf course may alter a format of a golf course on a given day according to one or more conditions such as weather events, maintenance and the like. Altering the format of the golf course may include altering the par requirements of one or more holes of the golf course. The groundskeeper often will not update requirements for the altered format with the handicap database provider or the service provider of the server computer 101. Accordingly, the golfer's determined score may not accurately account for conditions relating to format of the golf course.

In some arrangements, the golfer can select to register changed conditions of the format of the golf course when requesting the round of golf. For example, the golfer may select a “change format” check box displayed by the golf GUI and enter a hole number and updated par. When the server computer receives the request information at step 202, the application 133 executes to store a record of the change in format on the memory 109. If more than a predetermined number or threshold of requests are received from mobile devices of different users of the golf GUI to change the format of the nominated golf course in a given day, this can be considered validation of the change of course format. The application 133 may register the updated format for that day without any further validation and adjust the score determined at step 214 accordingly.

Additionally or alternatively, the service provider may contact the groundskeeper to validate the change of course format and enter confirmation of the change in format to the server computer 101.

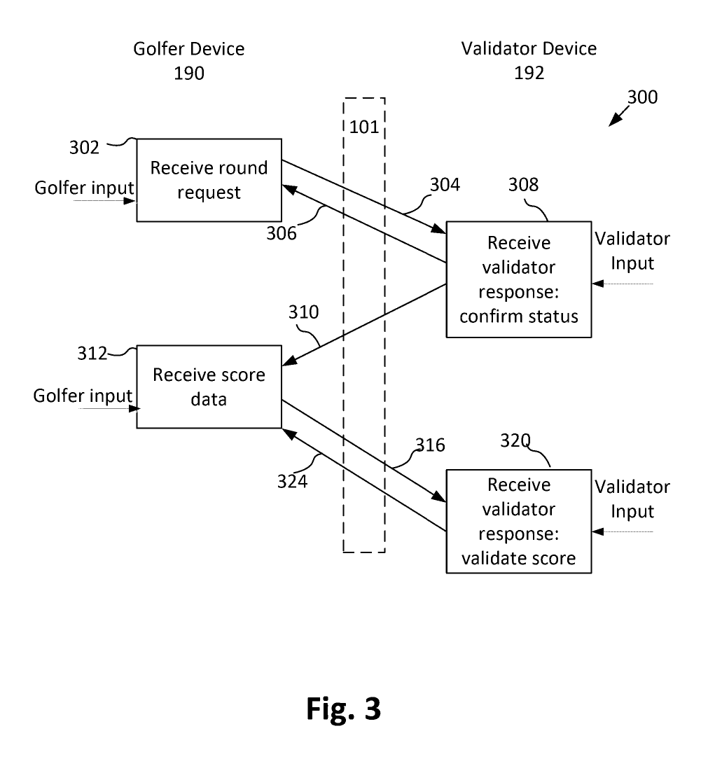

FIG. 3 shows an outline dataflow between the validator device 192 and the golfer device 190 in execution of the method 200. Communications other than input from a corresponding user are received by each of the devices 190 and 192 via the server computer 101. The server computer 101, shown in broken lines, is omitted from description in relation to FIG. 3 for ease of reference.

The dataflow 300 starts at step 302 when the golfer sets up the round. Setting up the round comprises the golfer device 192 receiving data input from the golfer to request a round of golf, as at step 202 of the method 200. The round set-up results in a notification being sent to the validator device 192 from the server computer 101, as indicated by an arrow 304.

The validator device 192 receives the notification of being nominated to be the golfer's validator, and the validator's response input at step 308. The validator interacts with the device 192 to confirm their status as a validator as described in relation to step 204 of FIG. 2. For example, the validator may decide to reject the nomination. Rejection results in a rejection message being transmitted to the golfer device 192, as indicated by an arrow 306. The round of golf cannot be nominated if a rejection message is transmitted to the golfer device (or the server computer 101).

In some arrangements, the request to play the round of golf may be cancelled if the validator status confirmation is not received within a predetermined amount of time. In such an instance, the golfer is required to resubmit the request (step 302) in order for the round of golf to be validated.

If, at step 308, the validator confirms validator status, a confirmation message is transmitted to the golfer device 190 as indicated by an arrow 310. Once the confirmation message has been received, the golfer can start to play the round of golf. The validator accompanies the golfer on the round, monitoring the golfer for accuracy of score and observation of rules. The validator may also play the round of golf, and in some cases may nominate the golfer as their validator, in a similar manner to that described above.

The data flow continues to step 312 when the round of golf is completed. At step 312, the golfer device 190 receives golfer input providing score data for the round of golf. Data corresponding to the validation request is resultantly transmitted from the server 101 to the validator device 192 for review and approval by the validator, as indicated by an arrow 316.

The validator device receives the validation request. At step 320, the validator device 192 receives input from the validator indicating whether the score is validated or not. Such results in transmission of a message to the golfer device 190 indicating whether the score has been validated or not, as shown by an arrow 324.

The arrangements described provide an effect of allowing the golfer to play in a golf competition at a convenient time. Validation of the score using the validator device provides a means of verifying that the score data for the round of golf is correct and according to the rules of golf. Further, in arrangements using location validations, comparison of the location of the golfer device 190, the validator device 192 and the recorded coordinates of the nominated course, verify that both the golfer was in the appropriate location. Such provides an increased degree of confidence in the validation received of the player's score data. The golfer accordingly is not necessarily required to play the round on a given day at a given time but at the golfer's own convenience. Organisers of the golfing competition are provided with a means of monitoring and verifying scores recorded for the competition.

As discussed below, validation of the score data allows for data feedback, normalisation of scores so players can play across a number of courses, competition structure and data collection.

Data Feedback

As well as a means of validating a score for a round of golf, the arrangements described provide a means of providing data feedback to the golfer via the golfing device 192.

The data feedback is provided through two mechanisms: (i) real-time feedback and (ii) post-round feedback. The data feedback may be comparing the golfer's performance against the golfer's own performance history. Examples of possible feedback against the golfer's own performance include:

“This is your first birdie on this hole.”

“This is your 8th birdie this month.”

“This is your 3rd eagle on SOGO.”

“You've shot par for 5 consecutive holes.”

Providing data feedback may involve comparing the golfer's performance against the performance history of other golfers. Examples of possible feedback against other golfers' performances include:

“You are the first female to birdie this hole.”

“You are the first golfer between the age of 18-29 to have 29 on these 9 holes.”

“You are the first golfer to have 7 pars on these 9 holes

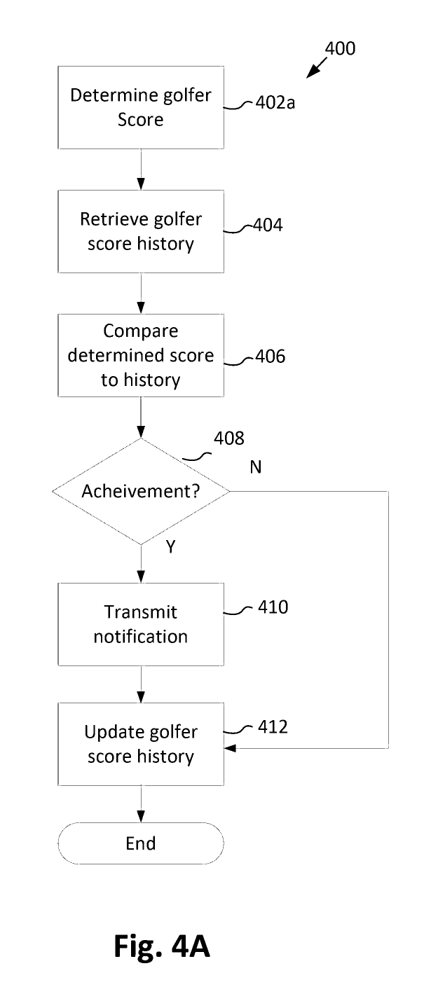

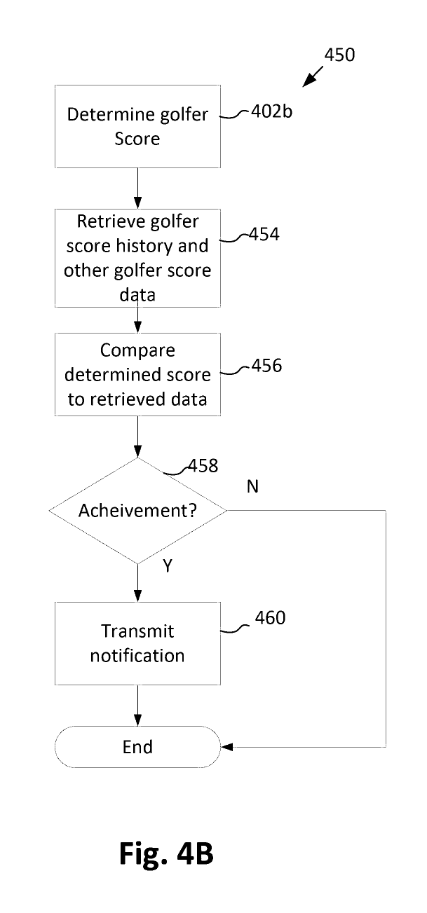

FIG. 4A shows a method 400 of determining real-time feedback to a golfer. The method 400 is implemented on the server computer 101 by one or more submodules of the application 133 and executed on the processor 105.

The method 400 starts at step 402a. At step 402a the golfer interacts with the golfer device 190 to provide score data after a hole of the round of golf. The server computer 101 receives the score data. Validation of the score data may not be required after a single round of golf, rather at the end of the round. The method 400 may be applied to scores that have yet to be validated, for example scores which will not be validated until the end of the round of golf.

The application 133 executes to determine a resultant score for the golfer according to the rules of golf, e.g., using stroke or Stableford rules. The application 133 may execute to retrieve data related to the player from one or more databases, such as a database stored on the memory 106 and/or a database external to the server computer 101. The retrieved data may include handicap data retrieved from the handicap database.

Once the score is determined, the method 400 proceeds to step 404. At step 404, the application 133 executes to retrieve data representing a score or performance history of the player from one or more databases. The databases may be local to the server computer 101, e.g., a database stored on the memory 106, or external to the server computer 101.

The method 400 proceeds from step 404 to step 406. At step 406, the application 133 executes to compare the score determined in step 402a to the performance history obtained in step 404. The comparison executed at step 406 is made in accordance with predetermined rules.

The method 400 proceeds from step 406 to step 408. At step 408, the application 133 determines whether the comparison relates to an achievement by the golfer. If the comparison is determined to result in an achievement (“Y” at step 408), the method 400 continues to step 410. An achievement may for example relate to a best score, or a series of best scores, a threshold of scores or the like. At step 410, a notification is transmitted to the golfer device 192. The notification typically comprises a message to be displayed by the golf GUI including details of the achievement.

The golfer is effectively provided with real-time feedback on their performance for the latest score data entered to the device 190.

The method 400 proceeds from step 410 to step 412. At step 412, the application 133 executes to update the golfer history by recording the determined score data at the relevant databases from which the performance history was obtained. If the comparison at step 408 is not determined to result in an achievement (“N” at step 408), the method 400 proceeds from step 408 to step 412. The method 400 ends after execution of step 412. The method 400 may be implemented for score data relating to a hole or an interval of a round of golf, or for a complete round of golf. Income arrangements where score data is input by the golfer on a hole-by-hole basis, congestion may occur in relation to the network 120 or processing capability of the processor 105. In such arrangements, the method 400 may only be executed after predetermined intervals—for example after every 3 holes of the round of golf.

Further, the method 400 may be executed in relation to validated or non-validated score data. Achievements reported to non-validated score data may later be removed, and score data deleted from the golfer score history if the score data is not validated at the end of the round.

FIG. 4B shows a method 450 of determining real-time feedback to a golfer. The method 450 is implemented by one or more submodules of the application 133 and executed on the processor 105. Feedback provided by the method 450 can relate to real-time performance or can relate to a completed round of golf. Feedback related to a completed round of golf may include a summary of the round of golf, how the golfer's round placed golfer in any competitions entered, and feedback comparing the golfer's performance to the golfer's own performance history and to the performance history of other golfers

The method 450 starts at step 402b. Step 402b operates in a similar manner to step 402a to determine the score for the complete round of golf. In contrast to step 402a of FIG. 4A, validation of the score data is typically required for step 402b to execute. The method 450 is typically executed after a round of golf has been completed and validated in accordance with the method 200.

Once the score is determined at step 402b, the method 450 proceeds to step 454. The application 133 executes to retrieve data representing a score or performance history of the golfer and other golfers in the same competition from one or more databases. The databases may be local to the server computer 101, e.g., a database stored on the memory 106, or external to the server computer 101.

The method 450 proceeds from step 454 to step 456. At step 456, the application 133 executes to compare the score determined in step 402b to the performance history of the golfer and other golfers in the competition obtained in step 454. The comparison executed at step 456 is made in accordance with predetermined rules.

The method 450 proceeds from step 456 to step 458. At step 458, the application 133 determines whether the comparison relates to an achievement by the golfer. An achievement in relation to the method 450 is similar to that for the method 400. However, in the method 450, the achievement may be filtered according attributes relating to the golfer such as state, gender, age, handicap, competitions entered, and the like. If the comparison is determined to result in an achievement (“Y” at step 458), the method 450 continues to step 460. At step 460, a notification is transmitted to the golfer device 192. The notification typically comprises a message to be displayed by the golf GUI including details of the achievement.

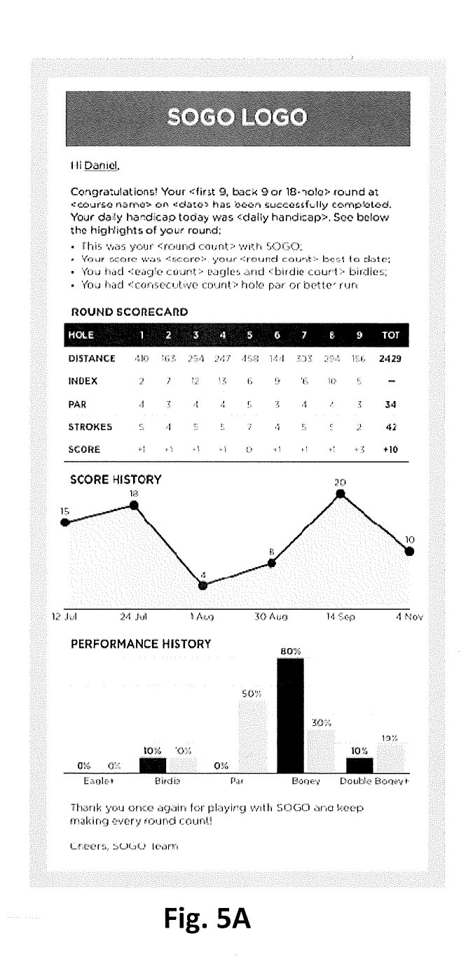

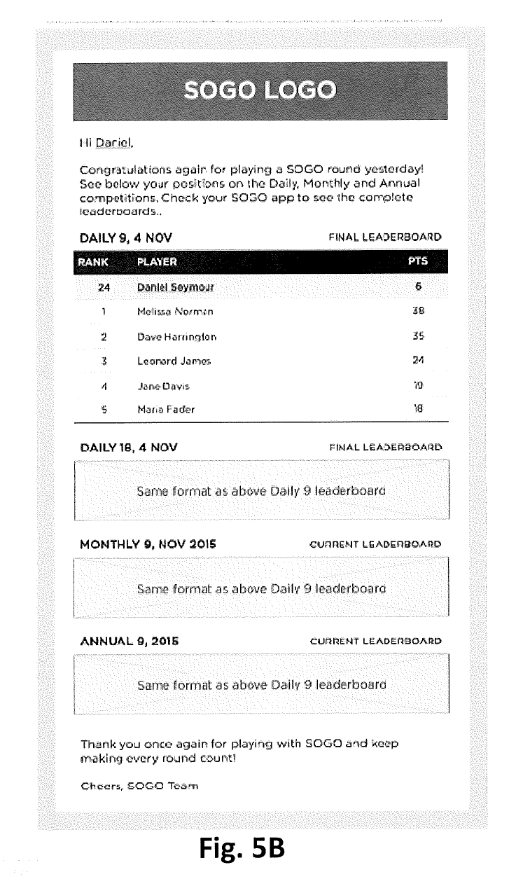

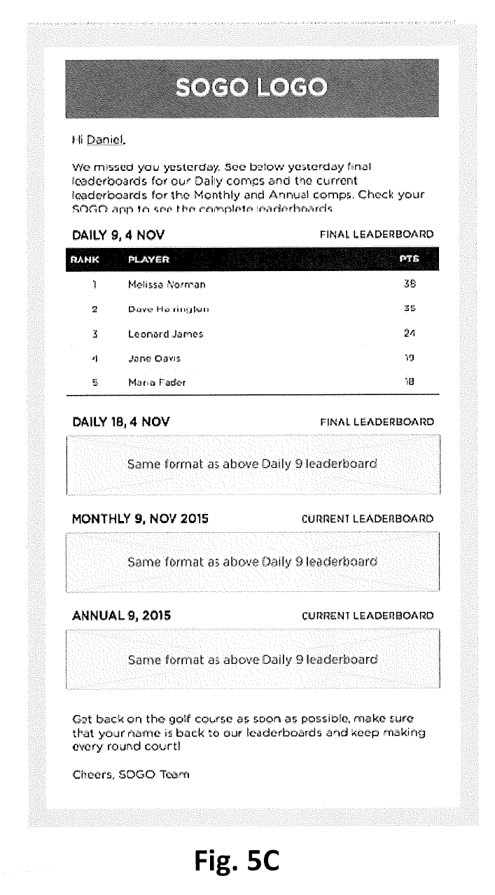

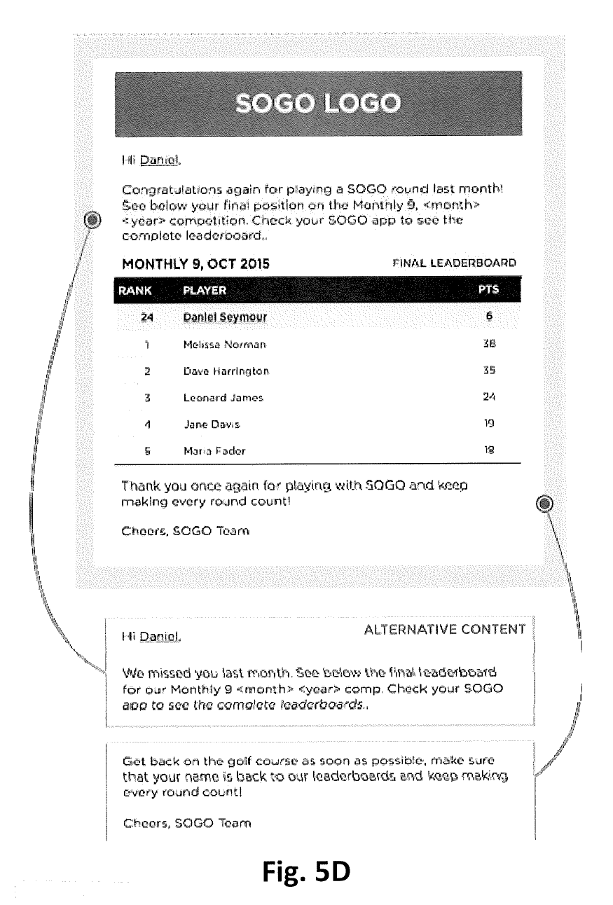

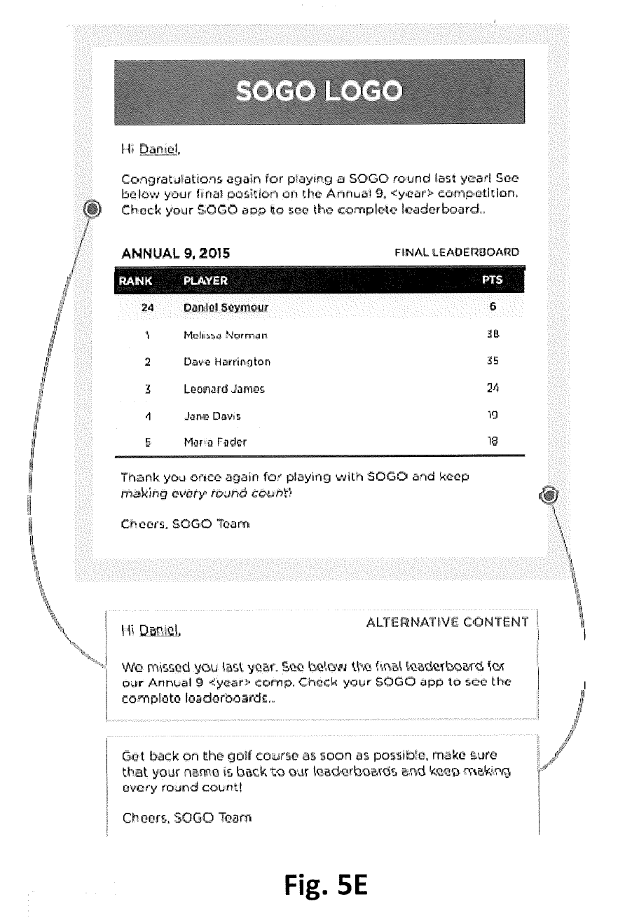

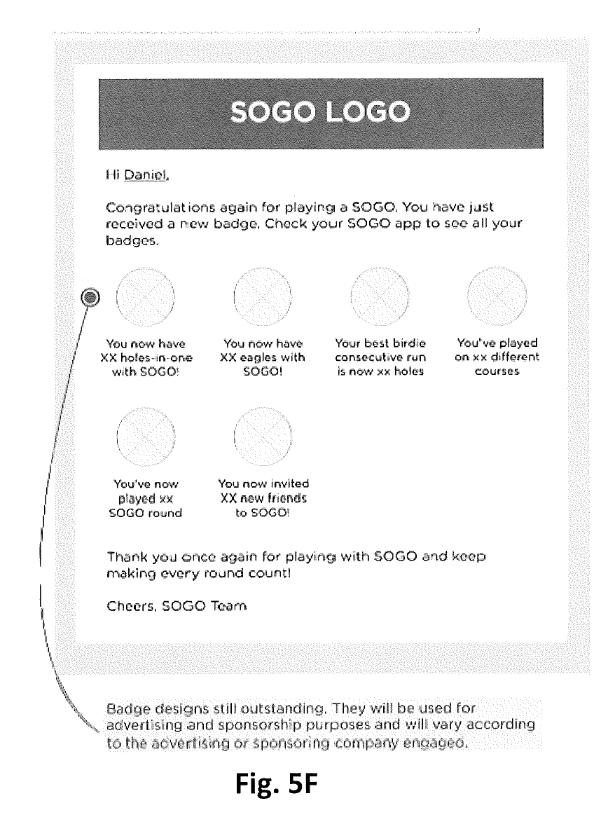

The methods 400 and 450 of data feedback can also be used to provide detailed feedback to the golfer via the golf GUI. FIGS. 5A to 5F show example presentations displayed by the golfer device 190 under execution of the golf GUI. FIGS. 5A to 5F show examples of the type of data feedback which may be provided using the arrangements described.

FIG. 5A shows an example report on a round of golf. The report of FIG. 5A provides information to the golfer regarding the score recorded for the round (as determined at step 214) and performance to date. The report of FIG. 5A includes round information such as congratulations messages for achievements (determined for example by operation of the method 450) and historical scores and relative performance of the golfer.

FIG. 5B show an example of information included in a daily report regarding competition status of the golfer. The report of FIG. 5B provides the golfer with information relating to a final position in competitions in which the golfer is entered such as “DAILY 18”, “MONTHLY 9” and “ANNUAL 9” competitions. Information included for each competition includes a current position and points score of the golfer, and position and points score of the top ten golfers.

FIG. 5C show an example of information included in a daily report regarding competition status of the golfer following a day on which the golfer did not play a validation round of golf. Unlike FIG. 5A, the report of FIG. 5C includes messages indicating that the golfer did not participate and encouraging the golfer to play more golf. Similarly to FIG. 5B, the report of FIG. 5C provides the golfer with information relating to a final position in competitions in which the golfer is entered.

FIG. 5D shows an example of information included in a monthly report regarding competition status of the golfer. The report of FIG. 5D provides the golfer with information relating to a final position in competitions in which the golfer is entered such as the “MONTHLY 9” competitions. Information included for each competition includes a current position and points score of the golfer, and position and points score of the top ten golfers.

FIG. 5E shows an example of information included in a monthly report regarding competition status of the golfer. The report of FIG. 5E provides the golfer with information relating to final positions in competitions in which the golfer is entered such as the “ANNUAL 9” competition. Information included for each competition includes a current position and points score of the golfer, and position and points score of the top ten golfers.

If the golfer has not been actively participating in golfing competitions over the relevant time period (over a month for FIG. 5D, a year for FIG. 5E), the reports shown in FIGS. 5D and 5E may include alternate messages encouraging the golfer to increase participation in using the interactive golf system.

The application 133 can also generate reports informing the golfer of any determined golfing achievements. Achievements may for example be classified in terms of badges, medals and trophies. A badge may relate to the golfer's determined score in relation to the golfer performance history, as calculated according to the method 400. Medals may relate to the golfer's determined score in relation to performance history of other golfers, as calculated according to the method 450. Trophies may relate to competitions which the golfer has won.

FIG. 5F shows an example report regarding badges generated by the server 101 and displayed to the golfer by execution of the golf GUI. The report of FIG. 5F provides badges relating to performance badges, based upon the determined score of step 212, tenacity badges relating to number of courses or rounds played, or social badges relating to introducing new users to the interactive golf service.

All of the reports of FIGS. 5A to 5F can in some instances include advertising such as banners, sales offers, embedded links and the like.

The arrangements described herein also provide benefits to owners and operators of golf clubs in terms of data feedback. Information regarding courses which a golfer has played at, number of visits per golf course, average time spent on each golf course and the like may be determined forms each validated instance of score data provided by the golfer to the server computer 101.

Competition Structure

The arrangements described allow golfers playing at different locations, at different times to compete in the same competition or competitions. The golfer plays a round at a golf course, tee box and time of their choosing according to the method 200 described above. Upon completion and validation of the round, a score for the golfer is determined, as at step 214.

The score is stored in the memory 106 in a database of scores. The scores are sorted by the application 133 using logic and rules to apply the parameters set by the rules of each competition. For example, one competition may be held on a given day or days day between all players in Australia on a number of golf courses. Another competition may be monthly 9-hole-round competition between a limited number of players.

For each competition, a set of rules may be stored in the memory 106. The rules may relate to standard rules such as stroke rules, Stableford rules, or custom rules and the like. The application 133 executes to apply corresponding rules to each validated score to determine a ranking of all competing golfers, and to determine a winner of the competition. The ranking of the players is determined and may be presented to each player in form of a leader board via the golf GUI.

The leader board can be sorted by the golfer interacting with the golfer device 190 to instruct the golf GUI to view players based on certain filters, such as state, name or golf course.

The golfer may for example want to navigate data available via a number of menus. Sample menus items may have heading such as Notifications, Play, Profile, Leaderboards and the like. The user golfer may want to view a short description of competitions in which the golfer is registered, and progress to view positions and points for all entrants in one of the competitions. The golfer may also want to access past leader boards and filter display of results of competitions according filters such as date, state, golf course, and golfer name. The golfer may want to return to view latest results or access detailed descriptions of competitions in which the golfer is entered by disabling appropriate filters. The golf GUI typically encompasses menu options to view and filter leader board results.

The application 133 may be configured to normalise scores such that registered users such as the golfer can play competitions across a number of different golf courses. For example, each player can be assigned a handicap for a given golf course.

FIG. 6 shows the method 600, as executed at step 202 of FIG. 2, for obtaining daily handicap information for the golfer. The method 600 may be implemented on the server computer 101 as one or more submodules of the application 133 and controlled by execution of the processor 105.

The arrangements described typically obtain handicap data from a single source for each golfer via the handicap database with which the service provider has made an arrangement. For golfers in Australia, the handicap provider can be Golf Link, for example. The method 600 represents steps executed on the server computer 101 and the handicap server.

The method 600 starts at step 602. At step 602, the golfer interacts with the device 190 to indicate via the golf GUI they are about to play a round (by selecting a course, tee box and validator). The server computer 101 receives the request, as at step 202.

The method 600 progresses from step 602 to step 604. At step 604, the application 133 executes to transmit a request to a handicap database to retrieve a daily handicap for the golfer. The handicap database is typically operated by an external service and accordingly not stored on the server computer 101. Transmitting a request for the daily handicap typically comprises sending a request to an application program interface (API) of the handicap database provider identifying a handicap registration number of the golfer, and the golf course.

The method 600 progresses from step 604 to step 606. At step 606 the handicap database responds to the request for the daily handicap by making the necessary adjustments to the handicap to generate the daily handicap. The daily handicap is the handicap of the golfer as adjusted for a slope rating (level of difficulty) of the nominated golf course.

The method 600 progresses from step 606 to step 608. At step 608, the handicap database transmits the daily handicap to the server computer 101.

The method 600 progresses from step 608 to step 610. At step 610, the application 133 executes to apply the daily handicap and adjust the par on each hole of the nominated golf course accordingly, and provide the resultant information to the golfer via the golfing device 190. The server computer 101 transmits the daily handicap information and the adjusted par information to the golfer device 190. The golf GUI executes to display the present a display of the handicap information and the adjusted par information.

The daily handicap is displayed to the golfer via the golf GUI executing on the golfer device 190. If the golfer is playing using the Stableford scoring method, the golf GUI executes to use the daily handicap to adjust the par for each hole in accordance with the rules of Stableford scoring.

In other arrangements, the handicap database may be stored on the server computer 101, or may be provided by the service provider operating the server computer 101. In other arrangements, some steps of the method 600 described as being executed on the server computer 101 may be executed on the golfer device 190 by operation of the golf GUI.

Additionally, in some arrangements, a rating, known as a “daily scratch rating”, may be determined for each golf course upon which a round of golf is played in a competition to normalise golfing scores. The daily scratch rating is determined appropriate to one or more conditions actually experienced by the golfer on the nominated golf course. A daily scratch rating is determined by comparison of an average net score calculated from submitted scores on a day, with the average net score expected for this precise field composition. The daily scratch rating is normally determined by the handicap database provider, and provides a means of normalising different courses and competitions to provide an even opportunity for all entrants in a golfing competition.

In some arrangements, the application 133 may use the scratch rating to adjust results of a competition, for example a monthly competition.

Results of competitions facilitated by the server computer 101 may be reported using a live leader board. The live leader board may be a leader board that shows a current position of all golfers registered with the service using the golf GUI within a given country, on a given day. The live leader board can include golfers that are currently playing a round, whose overall score has yet to be validated and golfers that have completed a round and whose score has been validated. Results of the live leader board may be viewed using filters including “Validated scores” and “Non-validated scores”. For golfers currently playing, the leader board indicates a last hole completed by each golfer.

The live leader board typically displays a name, current cumulative score and position in relation to par for each entrant golfer. Symbols may be used to show a position of the golfer score in relation to the golfer' par score. For example, “↑2” would indicate that the golfer has shot two strokes better than their par score, and “↓2” would indicate that the golfer has shot 2 strokes worse than their par score. “0” would indicate that the golfer is playing to their par score. The live leader board only includes golfers who enter and validate score data using the golf GUI at regular intervals through a nominated round of golf. Golfers who use a paper scorecard and subsequently upload score data via the golf GUI at a later time are not shown on the live leader board. The live leader board is updated based upon a score provided by the golfer using the golf GUI

Each golfer is ranked in the live leader board according to that golfer's position in relation to par. The highest score is ranked first (for example, ↑3 would be ranked more highly on the live leader board than ↑1). When the golfer enters a score for a hole using the golf GUI, as received at step 206 of the method 200, the application 133 executes to scorecard data (name, score, position in relation to par, and the holes completed) to a database stored on the server computer 101. The application 133 executes to sort the scoreboard data according to rules to determine the ranking of the golfer. The live leader board is accordingly updated.

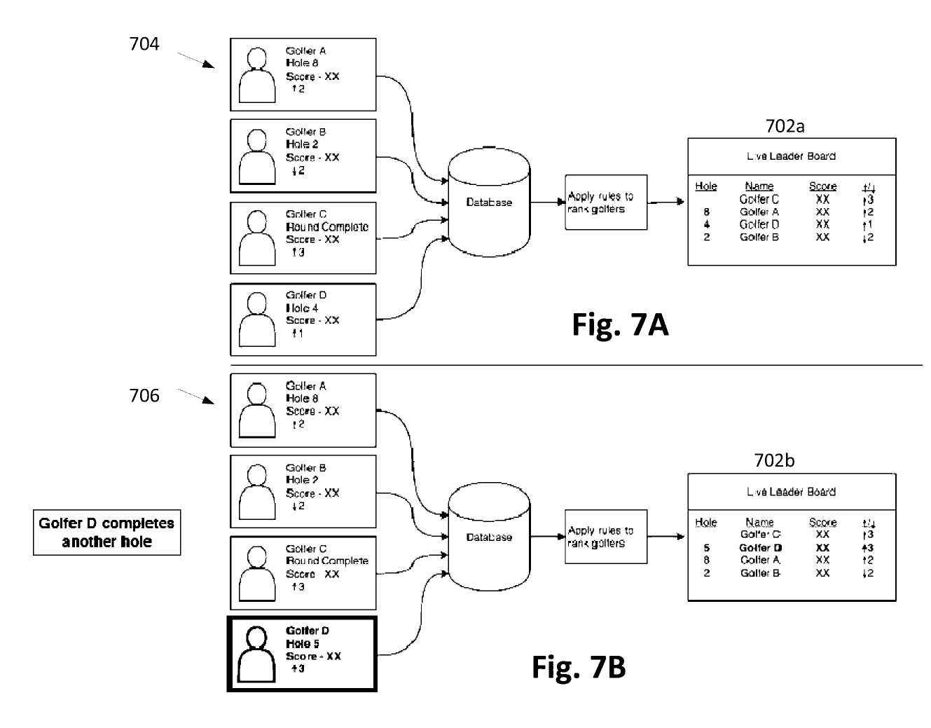

As the golfer plays each hole and provides score data for each hole, the updated data is similarly transmitted to the database, and the line leader board updated again. FIG. 7A shows a position of golfer D at a first point in time on a leader board 702a based upon a plurality of scores 704. FIG. 7B shows how the position of the golfer D has been updated on a leader board 702b after D completes another hole and based upon updated scores 706.

The leader board may also allow users to apply a filter and see golfers by certain criteria, such as state/territory, or gender, as described above.

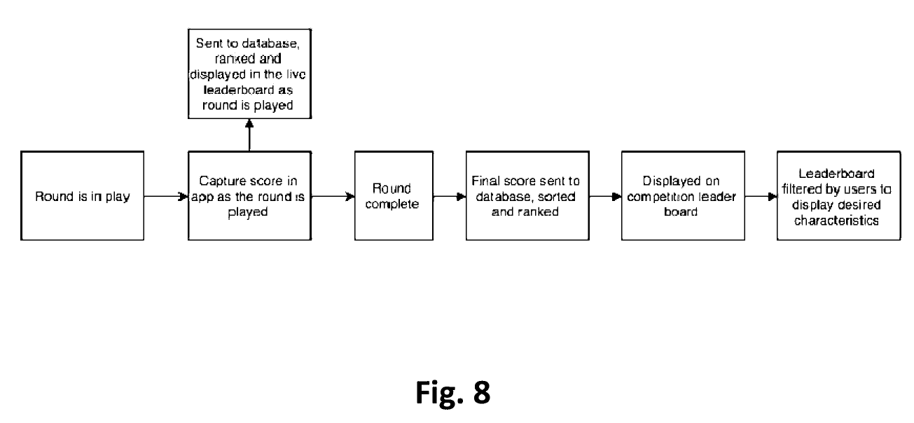

FIG. 8 shows a diagram 800 illustrating the relationship between the live leader board and structure of an overall competition. As can be seen from FIG. 8, the live leader board relates to “live” or real-time (and potentially unvalidated) scores for by each player in relation to the player's overall score in terms of par. However, a competition leader board relates to sorting and ranking of a final validated score for a round of golf, and a corresponding ranking of the golfer in that competition.

The service provided by the server computer 101 allows the registered golfer user to create custom competitions by interaction with the golf GUI. In custom competitions, the golfer selects the rules by which competitor data will be sorted and ranked. The golf GUI provides the golfer a number of parameters around which to structure the custom competition. Examples of parameters for structuring a custom competition include:

Date of the competition,

Duration,

Round type-9 or 18 holes,

Number of rounds eligible,

Golfers eligible,

Method of ranking eligible golfers,

Score type (for example, stroke, Stableford and the like), and

Golf courses eligible.

Once the user has defined the competition rules, the golfer plays a round of golf in the same manner as in a fixed competition as described above. When the round is complete, the score data is sent to the server computer 101, as in a fixed competition, but the application 133 applies the corresponding custom rules to sort the score data and rank the entrants. Different fee structures may be associated with setting up and running different types of competitions.

Examples of competitions which may be provided by the service provider, or created by the golfer, include:

Daily 9-hole round country-wide competition runs across all golf courses in a country. A best Stableford score of the day is submitted for the golfer.

Daily 18-hole round country-wide competition runs across all golf courses in the country. A best Stableford score of the day is submitted for the golfer.

Monthly 9-hole round country-wide competition runs across all golf courses in the country during each month. Top three Stableford scores are submitted for the golfer.

Annual 9-hole round Australia-wide competition runs across all golf courses in the country during each year from 1 November to 31 October. Top five Stableford scores are submitted for the golfer.

### INDUSTRIAL APPLICABILITY

The arrangements described are applicable to the computer and data processing industries and particularly for data processing related to the golf industry, and operation of golfing competitions.

The foregoing describes only some embodiments of the present invention, and modifications and/or changes can be made thereto without departing from the scope and spirit of the invention, the embodiments being illustrative and not restrictive.

1. A computer-implemented method, comprising the steps of:
receiving, from a golfer mobile device, a request to conduct a round of golf, the request comprising round information and identification of a validator mobile device,
receiving, from the validator mobile device, confirmation of validator status,
receiving, from the golfer mobile device, score data and location data of the golfer mobile device,
receiving, from the validator mobile device, location data of the validator mobile device,
determining whether the received score data is valid by comparing the location data of the golfer mobile device to the location data of the validator mobile device, and
determining and recording a score based on the score data for the golfer if the received score data is determined to be valid.

2. The method according to claim 1, wherein determining if the received score data is valid comprises receiving a score validation confirmation from the validator mobile device with the location data of the validator mobile device.

3. The method according to claim 1, determining if the received score data is valid comprises determining if the location data of the validator mobile device and the location data of the golfer mobile device are the same.

4. The method according to claim 1, wherein determining if the received score data is valid comprises determining if the location of the golfer mobile device and the location of the validator mobile device lie within a predetermined radius of one another.

5. The method according to claim 1, wherein determining if the received score data is valid comprises determining if the location of the golfer mobile device and the location of the validator mobile device correspond to a location of a golf course included in the round information.

6. The method according to claim 5, wherein determining if the received score data is valid comprises determining if the location of the golfer mobile device and the location of the validator mobile device lie within a given radius of the location of the golf course.

7. The method according to claim 5, wherein determining if the received score data is valid comprises determining if the location of the golfer mobile device and the location of the validator mobile device lie within a geo-fence associated with the golf course.

8. The method according to claim 1, further comprising:
comparing the determined score to a performance history of the golfer,
determining if the determined score relates to an achievement relative to the performance history,
transmitting a notification message if the determined score relates to an achievement relative to the performance history, and
updating the performance history of the golfer.

9. The method according to claim 1, further comprising:
comparing the determined score to performance history of a number of golfers,
determining if the determined score relates to an achievement relative to the performance history of the number of golfers, and
transmitting a notification message if the determined score relates to an achievement relative to the performance history of the number of golfers.

10. The method according to claim 1, wherein:
the round information includes location data of the golfer device at a time the request is made;
the confirmation of validator status includes location data of the validator mobile device at a time the validator status is confirmed; and
comparing the location data of the golfer device at a time the request is made and location data of the validator mobile device at a time the validator status is confirmed to determine if the confirmation of validator status is valid.

11. The method according to claim 1, wherein
the round information includes information regarding an updated format of a golf course; and
the updated format of the golf course is determined to be valid if received from a predetermined number of other mobile devices on a given day.

12. The method according to claim 1, further comprising updating a leader board based upon the score data for the hole in the round of golf.

13. The method according to claim 12, further comprising normalising the determined score based upon one or more conditions recorded for a number of players on a golf course associated with the round of golf on a given day.

14. The method according to claim 1 wherein receiving the confirmation of validator status comprises transmitting a notification to the validator mobile device; and receiving the confirmation in response to the notification from the validator mobile device.

15. The method according to claim 14, wherein the notification comprises a text message containing a uniform resource locator for a website by which the confirmation can be received.

16. The method according to claim 1, wherein an identity of a validator associated with the validator mobile device is validated using a registration of a handicap database.

17. The method according to claim 1, further comprising:
transmitting a request for a daily handicap for the golfer to a handicap database upon receiving the request to play a round of golf;
receiving the daily handicap from the handicap database; and
determining the score based upon the daily handicap.

18. A system comprising:
a golfer mobile device;
a validator mobile device,
a server computer; and
a communications network,
the server computer being in communication with the golfer mobile device, the server computer configured to:
receive, from the golfer mobile device, a request to conduct a round of golf, the request comprising round information, identification of the validator mobile device,
receive, from the validator mobile device, confirmation of validator status,
receive, from the golfer mobile device, score data and location data of the golfer mobile device,
receive, from the validator mobile device, location data of the validator mobile device,
determine whether the received score data is valid by comparing the location data of the golfer mobile device to the location data of the validator mobile device, and
determine and record a score based on the score data for the golfer if the received score data is determined to be valid.

19. A non-transitory computer readable storage medium having a computer program stored thereon comprising code for:
receiving, from a golfer mobile device, a request to conduct a round of golf, the request comprising round information, identification of a validator mobile device,
receiving, from the validator mobile device, confirmation of validator status,
receiving, from the golfer mobile device, score data and location data of the golfer mobile device,
receiving, from the validator mobile device, location data of the validator mobile device,
determining whether the received score data is valid by comparing the location data of the golfer mobile device to the location data of the validator mobile device, and
determining and recording a score based on the score data for the golfer if the received score data is determined to be valid.
